(19) United States
(12) Patent Application Publication
(10) Pub. No.: US 2026/0277077 A1
(43) Pub. Date: Sep. 17, 2026

(54) FILTER DEVICE AND IMAGING APPARATUS

(71) Applicant: SONY GROUP CORPORATION, TOKYO (JP)

(72) Inventors: TAKUMA TANAE, TOKYO (JP); OSAMU IIDA, TOKYO (JP); AKIHIRO OZAKI, TOKYO (JP)

(21) Appl. No.: 19/470,836

(22) PCT Filed: Mar. 25, 2024
(86) PCT No.: PCT/JP2024/011642

§ 371 Date: Sep. 30, 2025

(30) Foreign Application Priority Data
Apr. 11, 2023 (JP) 2023-064087

(51) Int. Cl. G03B 11/00; G03B 17/12

(52) U.S. Cl. CPC G03B 11/00; G03B 17/12

(57) ABSTRACT

A filter device includes: a first disk including a first neutral density filter; a second disk that is disposed to face the first disk in an optical axis direction, and includes a second neutral density filter; and a motor that gives a driving force to the first disk to rotate the first disk. In the filter device, an interlocking mechanism that enables the second disk to rotate with rotation of the first disk is provided. In this configuration, the first disk and the second disk are rotated by a single motor, and the filter device and an imaging apparatus can be made smaller in size with the reduced number of components and the simplified structure.

### TECHNICAL FIELD

The present technology relates to technical fields of a filter device in which two disks each having a neutral density filter are provided, and an imaging apparatus including the filter device.

### BACKGROUND ART

In various imaging apparatuses such as a video camera and a still camera, an imaging element such as a charge coupled device (CCD) or a complementary metal oxide semiconductor (CMOS) is provided, and a filter device having a neutral density filter is disposed on a subject side (object side) of the imaging element. The filter device has a function of performing luminance adjustment with the neutral density filter, and a light-reducing optical element called an ND filter having a function of reducing the amount of incident light is used as the neutral density filter.

In an imaging apparatus including such a filter device, two disks each having at least one neutral density filter are disposed side by side in the optical axis direction to enhance functionality in luminance adjustment, and luminance adjustment can be performed by a combination of neutral density filters placed on the optical axis (see Patent Document 1, for example).

In the filter device provided in the imaging apparatus disclosed in Patent Literature 1, two motors for rotating the two disks and a gear box including a reduction gear group are provided, one of the disks is rotated by a driving force of one of the motors, and the other disk is rotated by a driving force of the other motor. With such a configuration, the two disks are rotated independently of each other, and the image capturing person can perform luminance adjustment depending on an imaging state by setting the neutral density filter of each disk at a desired position.

### CITATION LIST

### Patent Document

Patent Document 1: WO 2021/200141 A

### SUMMARY OF THE INVENTION

### Problems to be Solved by the Invention

Meanwhile, a filter device as described above is provided inside an imaging apparatus, and therefore, it is desirable to reduce its size to simplify the structure and reduce the weight. In particular, a filter device is often used in a large imaging apparatus such as a television camera that is used while being placed on the shoulder or being held by hand, for example, and there is a high demand for miniaturization to reduce the weight in a case where the filter device is used in such a television Camera or the like.

Therefore, a filter device and an imaging apparatus according to the present technology aim to achieve miniaturization.

### Solutions to Problems

A filter device according to the present technology includes: a first disk including a first neutral density filter; a second disk that is disposed to face the first disk in an optical axis direction, and includes a second neutral density filter; and a motor that gives a driving force to the first disk to rotate the first disk. In the filter device, an interlocking mechanism that enables the second disk to rotate with rotation of the first disk is provided.

With this configuration, the first disk is rotated by the driving force of the motor, and the second disk is made rotatable in conjunction with rotation of the first disk by the interlocking mechanism.

An imaging apparatus according to the present technology includes: an imaging element that converts an optical image into an electrical signal; and a filter device that performs luminance adjustment, and the filter device includes: a first disk including a first neutral density filter; a second disk that is disposed to face the first disk in an optical axis direction, and includes a second neutral density filter; and a motor that gives a driving force to the first disk to rotate the first disk. In the filter device, an interlocking mechanism that enables the second disk to rotate with rotation of the first disk is provided.

With this configuration, in the filter device, the first disk is rotated by the driving force of the motor, and the second disk is made rotatable in conjunction with rotation of the first disk by the interlocking mechanism.

### BRIEF DESCRIPTION OF DRAWINGS

FIG. 1 illustrates an embodiment of a filter device and an imaging apparatus according to the present technology in conjunction with FIGS. 2 to 11, and this drawing is a conceptual diagram of the imaging apparatus.

FIG. 2 is an exploded perspective view of the filter device.

FIG. 3 is a perspective view of the filter device, with some portions thereof omitted.

FIG. 4 is an exploded perspective view of a click lever and a second support base.

FIG. 5 is a perspective view of an interlocking mechanism.

FIG. 6 illustrates rotating operations in the filter device in conjunction with FIGS. 7 to 10, and this drawing is a rear view illustrating an initial state.

FIG. 7 is a rear view illustrating a state in which a first disk is rotated in one direction with respect to a second disk, continuing from FIG. 6.

FIG. 8 is a rear view illustrating a state in which the first disk is rotated together with the second disk in one direction, continuing from FIG. 7.

FIG. 9 is a rear view illustrating a state in which the first disk is rotated in the other direction with respect to the second disk, continuing from FIG. 8.

FIG. 10 is a rear view illustrating a state in which the first disk is rotated in the other direction with respect to the second disk, continuing from FIG. 9.

FIG. 11 is a block diagram illustrating an example of an imaging apparatus.

### MODE FOR CARRYING OUT THE INVENTION

In the description below, a mode for carrying out the present technology will be explained with reference to the accompanying drawings.

In the embodiment described below, an imaging apparatus according to the present technology is applied to a video camera. Note that the range of application of the present technology is not limited to video cameras, and can be widely applied to other imaging apparatuses such as still cameras, for example.

In the description below, a front-rear direction, a vertical direction, and a transverse direction are indicated as directions as seen from the image capturing person. Accordingly, the subject side (the object side) is the front side, and the image capturing person's side (the image side) is the rear side.

Note that the front-rear, vertical, and transverse directions mentioned below are adopted for ease of explanation, and embodiments of the present technology are not limited by these directions.

### Schematic Configuration of Imaging Apparatus

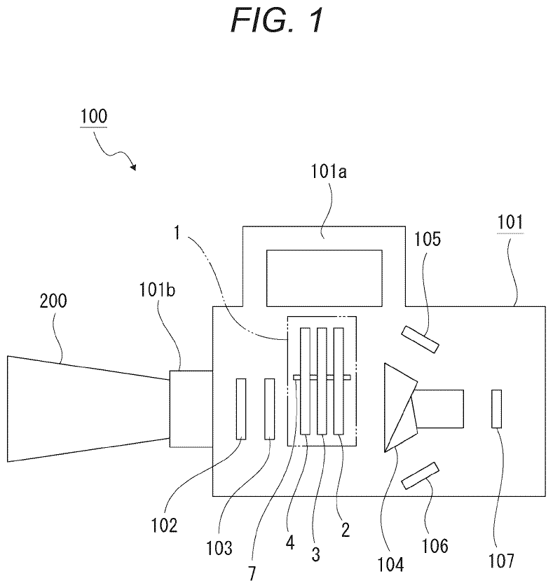

First, a schematic configuration of an imaging apparatus 100 is described (see FIG. 1). The imaging apparatus 100 is used as a television camera for television broadcasting, for example.

The imaging apparatus 100 includes an apparatus main body 101, and the respective relevant components are disposed inside and outside the apparatus main body 101. The apparatus main body 101 has a handle 101a to be gripped by the image capturing person on the upper side. A front end portion of the apparatus main body 101 is provided as an attaching portion 101b.

A lens device 200 functioning as an interchangeable lens is detachably attached to the attaching portion 101b of the apparatus main body 101. Light is taken into the imaging apparatus 100 via the lens device 200.

In the apparatus main body 101, a low-pass filter 102, a retardation plate 103, a filter device 1, and a color separation prism 104 are disposed in this order from the front side.

The low-pass filter 102 is a filter that attenuates and cuts off signals in a higher frequency range than a specific threshold by a birefringence effect and passes only low-frequency signals, and the low-pass filter 102 is used to cut off high-frequency signals that are likely to generate noise.

Therefore, to improve image quality, the low-pass filter 102 disposed on the optical axis is a necessary component.

The structure of the filter device 1 will be described later in detail, but a ND filter having a function of reducing the amount of light to enter is provided in the filter device 1, and luminance adjustment is performed by the filter device 1.

The retardation plate 103 has a function of changing a polarization state by delaying the phase of one component of polarized light with respect to a component orthogonal thereto, and transmitting light without attenuation, to correct the polarization state.

As the low-pass filter 102 is used in the imaging apparatus 100, a phase delay occurs for each wavelength due to the birefringence effect, and there is a possibility that a rainbow-like pattern due to interference will occur when phase-delayed polarized light rays travel straight in an orthogonal state and pass through the filter device 1. Therefore, the retardation plate 103 is disposed between the low-pass filter 102 and the filter device 1 as described above, so that the polarization state is corrected by the resultant larger phase delay, and the occurrence of rainbow-like patterns due to interference can be reduced.

As the retardation plate 103 is disposed between the filter device 1 and the low-pass filter 102 in the imaging apparatus 100 as above, the phase delay caused for each wavelength by the birefringence effect of the low-pass filter 102 is increased by the retardation plate 103, the generation of a rainbow-like pattern is reduced, and thus, image quality can be enhanced.

The color separation prism 104 has a function of separating light that has entered through the filter device 1 into predetermined color components, such as a red component (R), a green component (G), and a blue component (B), for example, and directing the respective components in predetermined directions.

Three imaging elements 105, 106, and 107 are disposed in the apparatus main body 101. Light of each of the red component, the green component, and the blue component separated by the color separation prism 104 is made to enter the imaging elements 105, 106, and 107, respectively, and is converted into an electrical signal (imaging signal) through photoelectric conversion performed by the imaging elements 105, 106, and 107.

Predetermined processing such as white-balance calibration and y correction is performed on the converted imaging signals, so that a video signal in a predetermined format is generated by a signal processing circuit or the like. Note that the imaging apparatus 100 does not necessarily have a so-called three-plate configuration including the color separation prism 104 and the three imaging elements 105, 106, and 107, and may have a so-called single-plate configuration using a single imaging element.

### Configuration of Filter Device

Next, a configuration of the filter device 1 is described (see FIGS. 1 to 5).

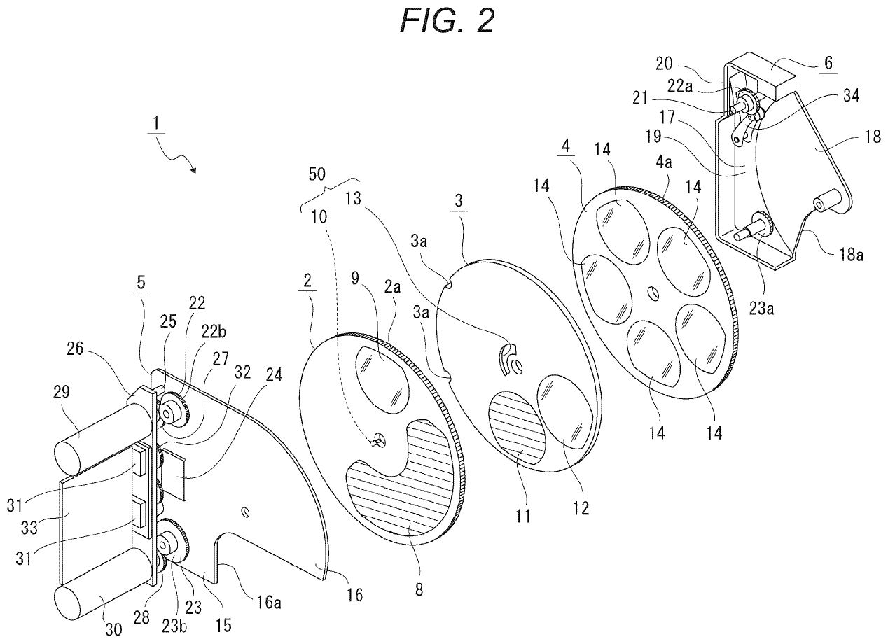

The filter device 1 includes a first disk 2, a second disk 3, a third disk 4, a first support base 5, a second support base 6, and a drive mechanism (see FIGS. 1 and 2).

The first disk 2, the second disk 3, and the third disk 4 are formed in a disk-like shape of the same size, and the central axes (rotation axes) thereof are aligned with one another. The first disk 2, the second disk 3, and the third disk 4 are located in this order from the rear side, for example, and are rotatable in both directions. The first disk 2 and the second disk 3 are positioned so as to face each other in the optical axis direction, and the second disk 3 and the third disk 4 are positioned so as to face each other in the optical axis direction. A support shaft 7 penetrates through the center portions of the first disk 2, the second disk 3, and the third disk 4, and each of the first disk 2, the second disk 3, and the third disk 4 is rotated about the support shaft 7 serving as the point of support (see FIG. 1).

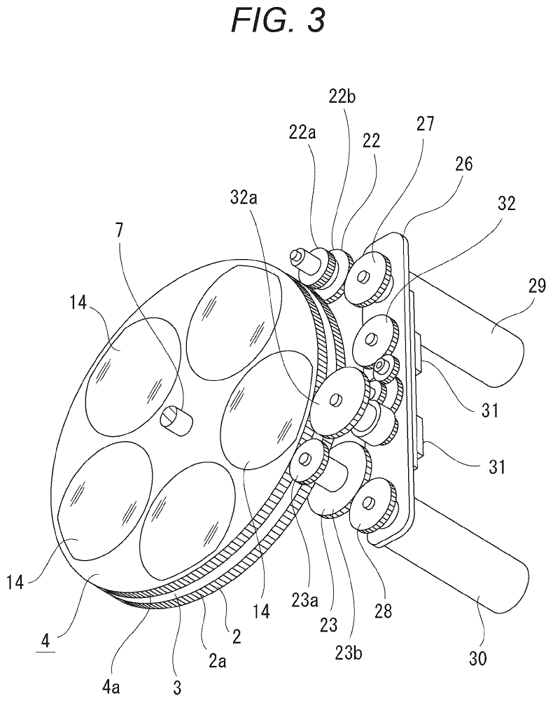

The first disk 2 includes a first neutral density filter 8 and a first clear filter 9 (see FIGS. 2 and 3). The first neutral density filter 8 is a polarizing filter that functions as an ND filter, has a function of converting transmitted light into linearly polarized light in a predetermined direction, and is formed in an arc-like shape extending in a circumferential direction and having the center of the first disk 2 as the point of support, for example. The first clear filter 9 is a filter that does not optically affect transmitted light, and is formed in a substantially circular shape. The first neutral density filter 8 and the first clear filter 9 are disposed side by side in the direction of rotation of the first disk 2.

A gear portion 2a is formed on the entire outer peripheral surface of the first disk 2. An acting protrusion 10 protruding toward the second disk 3 is provided on an inner peripheral portion of the first disk 2. A large number of reflective surfaces (not shown) are formed at equal intervals in the circumferential direction on an outer peripheral portion of the rear surface of the first disk 2.

The second disk 3 includes a second neutral density filter 11 and a second clear filter 12. The second neutral density filter 11 is a polarizing filter that functions as an ND filter, for example, has a function of converting transmitted light into linearly polarized light in a predetermined direction, and is formed in a substantially circular shape. The second clear filter 12 is a filter that does not optically affect transmitted light, and is formed in a substantially circular shape. The second neutral density filter 11 and the second clear filter 12 are disposed side by side in the direction of rotation of the second disk 3.

On an outer peripheral surface of the second disk 3, a plurality of or two engagement recesses 3a that are open outward are formed at a distance from each other in a circumferential direction, for example. A receiving groove 13 that is open toward the first disk 2 is formed on an inner peripheral portion of the second disk 3, and the receiving groove 13 extends in the circumferential direction and is formed in an arc-like shape using the center of the second disk 3 as the point of support.

The third disk 4 includes a plurality of optical filters 14. The optical filters 14 are formed in a substantially circular shape, and are disposed side by side at equal intervals in the direction of rotation of the third disk 4. The plurality of optical filters 14 is formed with filters of different types, and, other than clear filters, cross filters that emphasize glitter by making point light sources to emit cross-shaped light, bandpass filters that transmit light in a predetermined wavelength range, or the like are used as the optical filters 14.

A gear portion 4a is formed on the entire outer peripheral surface of the third disk 4.

The first support base 5 is formed with a metal material in a flat plate-like shape facing the front-rear direction, for example, and includes a first support surface portion 15 formed in a substantially rectangular shape that is vertically long, and a first protruding surface portion 16 protruding laterally from the first support surface portion 15. As the first support base 5 is formed with a metal material, high rigidity can be ensured while thickness reduction is ensured.

The second support base 6 includes a second support surface portion 17 formed in a substantially arc-like shape, and a second protruding surface portion 18 protruding laterally from the second support surface portion 17. In the second support base 6, the second support surface portion 17 is formed with a resin material, for example, and the second protruding surface portion 18 is formed with a metal material, for example. As the second support surface portion 17 is formed with a resin material, it is possible to easily form a desired shape with high precision. As the second protruding surface portion 18 is formed with a metal material, it is possible to ensure high rigidity while ensuring a reduction in thickness.

The second support surface portion 17 includes a base surface portion 19 having a flat plate-like shape facing the front-rear direction, and a peripheral surface portion 20 protruding rearward from a portion of an outer peripheral portion of the base surface portion 19 excluding the portion continuing to the second protruding surface portion 18.

The first support base 5 is located on the rear side of the second support base 6, and the first support surface portion 15 of the first support base 5 and the peripheral surface portion 20 of the second support base 6 are joined by screwing or the like. Accordingly, a component placement space is formed between the first support base 5 and the second support base 6.

A cutout portion 16a and a cutout portion 18a that are open downward and laterally are formed in the first protruding surface portion 16 and the second protruding surface portion 18, respectively. The space formed by the cutout portion 16a and the cutout portion 18a is a space on the optical axis.

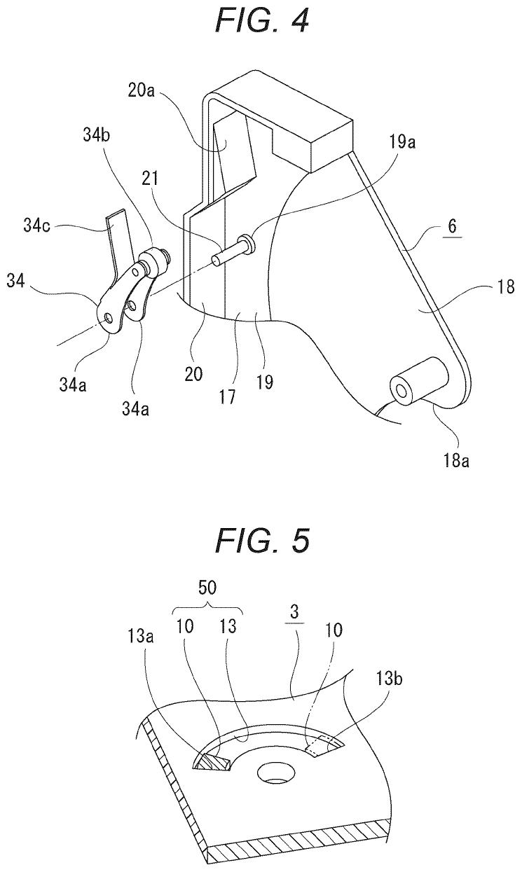

A shaft attachment portion 19a protruding rearward is provided on the base surface portion 19 of the second support surface portion 17, and one end portion of a shaft member 21 extending forward and rearward is inserted and attached to the shaft attachment portion 19a (see FIG. 4). On an inner surface of the peripheral surface portion 20 of the second support surface portion 17, a spring-receiving surface 20a is formed at a position on the upper side of the shaft attachment portion 19a.

A first reduction gear group 22 and a second reduction gear group 23 are supported on the first support surface portion 15 and the second support surface portion 17 (see FIGS. 2 and 3).

The first reduction gear group 22 and the second reduction gear group 23 are vertically separated from each other, and a portion thereof is located on the rear surface side of the first support surface portion 15 while the other portion thereof is located in the component placement space formed between the first support surface portion 15 and the second support surface portion 17.

In the first reduction gear group 22 and the second reduction gear group 23, gears located on the foremost side are provided as a first transmission gear 22a and a second transmission gear 23a, respectively, and gears located on the rearmost side are provided as a second transmission gear 23a and a second interlocking gear 23b, respectively. Each of the first transmission gear 22a and the second transmission gear 23a is supported on the rear surface side by the base surface portion 19 of the second support surface portion 17, and each of the first interlocking gear 22b and the second interlocking gear 23b is supported on the rear surface side by the first support surface portion 15.

In the first reduction gear group 22, the first transmission gear 22a is meshed with the gear portion 2a of the first disk 2, and, in the second reduction gear group 23, the second transmission gear 23a is meshed with the gear portion 4a of the third disk 4.

The respective end portions of the support shaft 7 in the axial direction are fixed to the first protruding surface portion 16 and the second protruding surface portion 18.

Accordingly, the first disk 2, the second disk 3 and the third disk 4 are separately made rotatable with respect to the support shaft 7 between the first support base 5 and the second support base. At this point of time, the acting protrusion 10 provided on the first disk 2 is inserted into the receiving groove 13 formed in the second disk 3, and the acting protrusion 10 and the receiving groove 13 constitute an interlocking mechanism 50 (see FIG. 5). The other end portion of the shaft member 21 is attached to the first support surface portion 15.

A sensor board 24 is attached to the rear surface of the first support surface portion 15 (see FIG. 2). A detector (not shown) is mounted on the front surface of the sensor board 24, and the detector includes a light emitting unit and a light receiving unit. The detector is disposed in a placement hole (not shown) formed in the first support surface portion 15, emits light from the light emitting unit toward an outer peripheral portion of the first disk 2, and receives, with the light receiving unit, the light reflected by a reflective surface formed on the outer peripheral portion of the first disk 2. Thus, the rotational position of the first disk 2 is detected by the detector on the basis of the light received by the light receiving unit.

An attachment plate 26 is attached to the rear surface side of the first support surface portion 15 via a pair of support pins 25. The attachment plate 26 is formed in a vertically long shape, and is disposed at a distance rearward from the rear surface of the first support surface portion 15. On the front surface side of the attachment plate 26, a first motor gear 27 and a second motor gear 28 are supported in a vertically separated state (see FIGS. 2 and 3). The first motor gear 27 is meshed with the first interlocking gear 22b of the first reduction gear group 22, and the second motor gear 28 is meshed with the second interlocking gear 23b of the second reduction gear group 23.

To the rear surface side of the attachment plate 26, a first motor 29 and a second motor 30 are attached in a vertically separated state. Output shafts of the first motor 29 and the second motor 30 penetrate through the attachment plate 26, and are fixed to the first motor gear 27 and the second motor gear 28, respectively.

Accordingly, a driving force of the first motor 29 is transmitted from the first motor gear 27 to the first disk 2 via the first reduction gear group 22, and the first disk 2 is rotated in a direction corresponding to the direction of rotation of the first motor 29. Also, a driving force of the second motor 30 is transmitted from the second motor gear 28 to the third disk 4 via the second reduction gear group 23, and the third disk 4 is rotated in a direction corresponding to the direction of rotation of the second motor 30.

On the attachment plate 26, two potentiometers 31 are attached in a vertically separated state on the rear surface side, and a detecting reduction gear group 32 is supported on the front surface side. The potentiometers 31 are connected to the detecting reduction gear group 32. In the detecting reduction gear group 32, the frontmost gear is provided as a meshing gear 32a, and the meshing gear 32a is meshed with the gear portion 4a of the third disk 4.

Accordingly, when the third disk 4 is rotated by a driving force of the second motor 30, the rotational force is transmitted to the potentiometers 31 via the detecting reduction gear group 32, and the potentiometers 31 are rotated in conjunction with rotation of the third disk 4. As the potentiometers 31 are rotated in conjunction with rotation of the third disk 4, the angle of rotation (rotational position) of the third disk 4 is detected by the potentiometers 31. At this point of time, one of the potentiometers 31 is decelerated with respect to the speed of rotation of the third disk 4 by the detecting reduction gear group 32, or is rotated at ⅕ times the speed of rotation, for example, and thus, the angle of rotation of the third disk 4 is detected with high accuracy. Furthermore, since the two potentiometers 31 are used in the filter device 1, it is possible to detect the angle of rotation of the third disk 4 with higher accuracy.

A control board 33 is attached to the rear surface side of the attachment plate 26. The control board 33 is connected to the sensor board 24. The first motor 29 and the second motor 30, the potentiometers 31, and the like are controlled by the control board 33.

A click lever 34 is rotatably supported by the second support surface portion 17 (see FIGS. 2 and 4). The click lever 34 is located immediately below the first reduction gear group 22 in the component placement space formed between the first support surface portion 15 and the second support surface portion 17, and includes a pair of arm portions 34a, an engagement roller 34b rotatably supported by the tip portions of the pair of arm portions 34a, and a leaf spring portion 34c protruding from the arm portions 34a.

In the click lever 34, the shaft member 21 is inserted through the base end portions of the pair of arm portions 34a, and is rotatable about the shaft member 21 serving as the point of support. In the click lever 34, the tip portion of the leaf spring portion 34c is pressed against the spring-receiving surface 20a of the second support surface portion 17. Accordingly, the click lever 34 is biased in a direction in which the engagement roller 34b is separated from the peripheral surface portion 20 of the second support surface portion 17, and the engagement roller 34b is pressed against the outer peripheral surface of the second disk 3. When the second disk 3 rotates, the engagement roller 19b is rotated while being pressed against the outer peripheral surface of the second disk 3.

### Rotating Operations in Filter Device

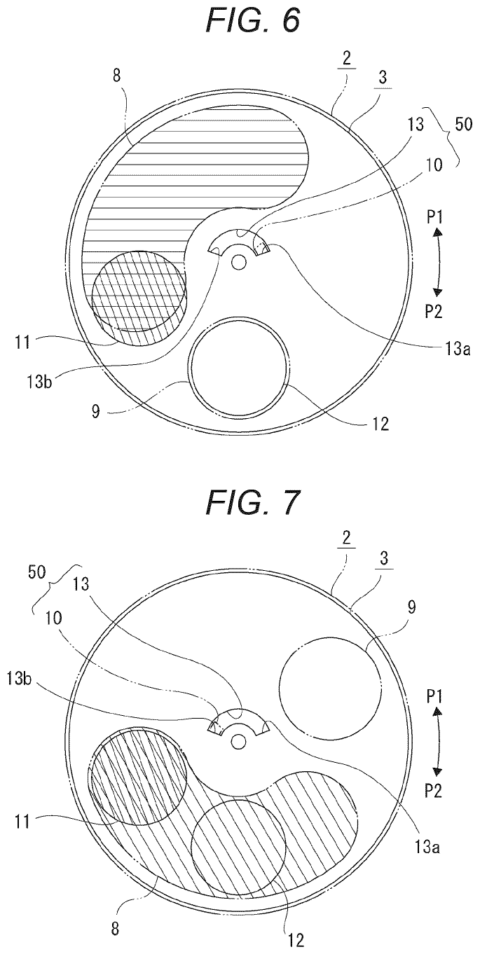

In the following, rotating operations for the first disk 2 and the second disk 3 in the filter device 1 configured as described above are described (see FIGS. 6 to 10). Note that, in FIGS. 6 to 10, to facilitate understanding, the first disk 2 and the second disk 3 are shown in different sizes for convenience.

The first disk 2 and the second disk 3 are rotated, so that luminance adjustment is performed.

In the initial state of imaging, the acting protrusion 10 of the first disk 2 is placed at one end of the receiving groove 13 in the second disk 3, for example, and the acting protrusion 10 is put into contact with a first opening edge 13a on one side of the receiving groove 13 (see FIG. 6). On the optical axis at this point of time, the first clear filter 9 of the first disk 2 and the second clear filter 12 of the second disk 3 overlap each other in the front-rear direction. Accordingly, transmitted light is not optically affected, light reduction is not performed, and, in that state, the intensity of light is set to 1/1.

In such an initial state, the engagement roller 19b of the click lever 34 is inserted into and engaged with one of the engagement recesses 3a of the second disk 3, and the second disk 3 is held at the rotational position where the second clear filter 12 is located on the optical axis.

When the first disk 2 is rotated in a P1 direction by the driving force of the first motor 29, the acting protrusion 10 is moved in the receiving groove 13, and the first disk 2 is rotated with respect to the second disk 3 in a state where the second disk 3 is in a stopped state (see FIG. 7). On the optical axis at this point of time, some portion of the first neutral density filter 8 of the first disk 2 and the second clear filter 12 of the second disk 3 overlap each other in the front-rear direction. The acting protrusion 10 is moved to a position in contact with a second opening edge 13b on the other side of the receiving groove 13.

When the first disk 2 is rotated with respect to the second disk 3, the second disk 3 is not rotated, and accordingly, a state in which the engagement roller 19b of the click lever 34 is inserted into and engaged with one of the engagement recesses 3a of the second disk 3 is maintained.

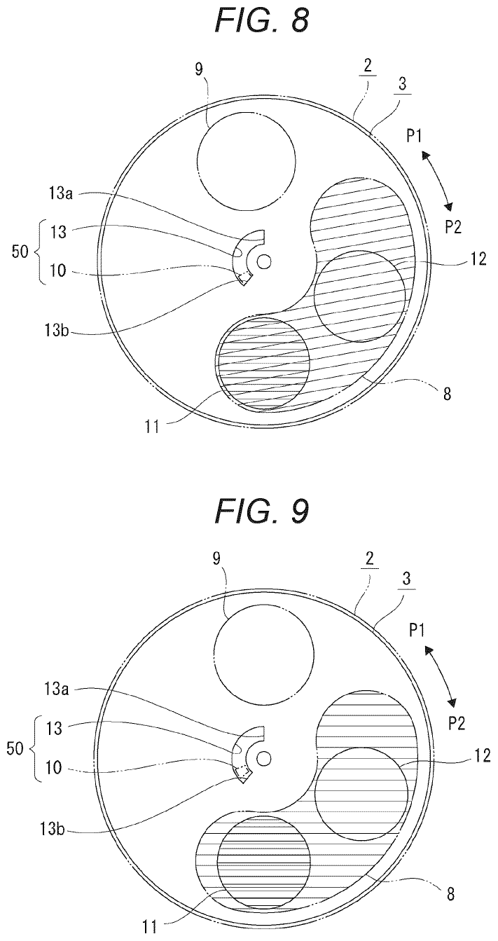

The first disk 2 continues to be rotated in the P1 direction by the driving force of the first motor 29 (see FIG. 8). As the first disk 2 continues to be rotated in the P1 direction, the second opening edge 13b of the receiving groove 13 is pressed by the acting protrusion 10, and the second disk 3 is rotated together with the first disk 2 in the P1 direction (see FIG. 7). The first disk 2 and the second disk 3 are rotated until the second neutral density filter 11 of the second disk 3 is placed on the optical axis, and one end portion of the first neutral density filter 8 in the circumferential direction and the second neutral density filter 11 are brought into an overlapped state in the front-rear direction on the optical axis.

At this point of time, the intensity of the transmitted light is reduced to 1/2, for example, depending on the combination of the polarization direction of the first neutral density filter 8 and the polarization direction of the second neutral density filter 11. Note that, in the filter device 1, by arbitrarily setting the polarization direction of the first neutral density filter 8 and the polarization direction of the second neutral density filter 11, it is possible to set the intensity of light in a state where one end portion of the first neutral density filter 8 in the circumferential direction and the second neutral density filter 11 overlap each other in the front-rear direction, to any desired intensity other than 1/2.

When one end portion of the first neutral density filter 8 in the circumferential direction and the second neutral density filter 11 are in an overlapped state in the front-rear direction on the optical axis, the engagement roller 19b of the click lever 34 is inserted into and engaged with the other one of the engagement recesses 3a of the second disk 3, and the second disk 3 is held at the rotational position at which the second neutral density filter 11 is placed on the optical axis.

When the second disk 3 is rotated until the second neutral density filter 11 is placed on the optical axis, the first motor 29 is temporarily stopped and is rotated in the opposite direction from the above (see FIG. 9). As the first motor 29 is rotated, the acting protrusion 10 is moved in the receiving groove 13, and the first disk 2 is rotated with respect to the second disk 3 in a P2 direction that is the opposite direction from the P1 direction, while the second disk 3 is in a stopped state. On the optical axis at this point of time, some portion of the first neutral density filter 8 of the first disk 2 and the second neutral density filter 11 of the second disk 3 overlap each other in the front-rear direction.

When the first disk 2 is rotated with respect to the second disk 3, the second disk 3 is not rotated, and accordingly, a state in which the engagement roller 19b of the click lever 34 is inserted into and engaged with the other one of the engagement recesses 3a of the second disk 3 is maintained.

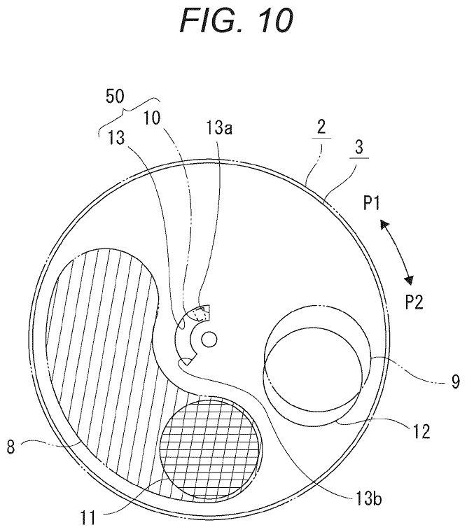

The first motor 29 is stopped when rotated by the number of rotations according to the image capturing person's operation, and a portion of the first neutral density filter 8 and the second neutral density filter 11 are put into an overlapped state in the front-rear direction on the optical axis. At this point of time, the intensity of the transmitted light is continuously changed in accordance with the rotation of the first disk 2, depending on the combination of the polarization direction of the first neutral density filter 8 and the polarization direction of the second neutral density filter 11. The intensity of the transmitted light is continuously changed from a state with 1/3 (see FIG. 9) to a state with 1/256 (see FIG. 10), for example.

Accordingly, when the other end portion of the first neutral density filter 8 in the circumferential direction and the second neutral density filter 11 overlap each other in the front-rear direction on the optical axis, the intensity of light is reduced to 1/256 (see FIG. 10), for example.

When the imaging is finished, and the power button of the imaging apparatus 100 is operated to turn off the power, for example, the first disk 2 is rotated in the P2 direction by the driving force of the first motor 29. As the first disk 2 is rotated in the P2 direction, the first opening edge 13a of the receiving groove 13 is pressed by the acting protrusion 10, and the second disk 3 is rotated together with the first disk 2 in the P2 direction, to return to the initial state (see FIG. 6).

Accordingly, the acting protrusion 10 is brought into contact with the first opening edge 13a of the receiving groove 13, the first clear filter 9 of the first disk 2 and the second clear filter 12 of the second disk 3 are brought into an overlapped state in the front-rear direction on the optical axis, and the engagement roller 19b of the click lever 34 is inserted into and engaged with one of the engagement recesses 3a of the second disk 3, to hold the second disk 3.

Note that the order of the rotating operations for the first disk 2 and the second disk 3 described above is an example, and the first disk 2 and the second disk 3 may be rotated in another order to perform luminance adjustment.

In the imaging apparatus 100, in addition to the rotating operations for the first disk 2 and the second disk 3 described above, a rotating operation for the third disk 4 is also performed. As described above, a rotating operation for the third disk 4 is performed by transmitting the driving force of the second motor 30 to the third disk 4.

As the third disk 4 is rotated, any one of the optical filters 14 is placed on the optical axis. By transmitting light through the optical filter 14 placed on the optical axis, it is possible to achieve a specific image effect depending on the type of the optical filter 14, such as an image effect by which point light sources is made to emit cross-shaped light to emphasize glitter, for example.

As described above, the third disk 4 including a plurality of optical filters 14 of different types positioned apart from each other in the circumferential direction is provided in the filter device 1. Thus, it is possible to form various imaging states by rotating the third disk 4 and changing the optical filters 14, and enhanced functionality can be achieved.

### Others

In the imaging apparatus 100, the filter device 1 described above can be replaced with another filter device. Another filter device is a filter device having a configuration in which two disks are provided, one of the disks has the first neutral density filter, the other disk has a plurality of optical filters including the second neutral density filter, and the intensity of light is continuously changed depending on the position of the second neutral density filter with respect to the first neutral density filter, for example. In this case, one of the disks is rotated by a driving force of one motor, and the other disk is rotated by a driving force of the other motor.

Note that, although the second disk 3 including the second neutral density filter 11 and the second clear filter 12 has been described as an example, the second disk 3 may include at least one other optical filter, in addition to the second neutral density filter 11 and the second clear filter 12, for example.

Also, an example in which the click lever 34 is used as a component for holding the second disk 3 at a predetermined rotational position has been described. However, the component for holding the second disk 3 at a predetermined rotational position is not necessarily the click lever 34, and a stopper component using magnetism or a component that applies braking by pressing an elastic member such as rubber may be used, for example.

Further, an example in which the acting protrusion 10 is provided on the first disk 2, and the receiving groove 13 is formed in the second disk 3 has been described above. However, it is also possible to adopt a configuration in which the receiving groove is formed in the first disk, and the acting protrusion is provided on the second disk.

Furthermore, it is also possible to adopt a configuration in which an acting protrusion protruding toward the second disk is provided on the first disk, a receiving protrusion protruding toward the first disk is provided on the second disk, and the first disk and the second disk are rotated together when the receiving protrusion is pressed by the acting protrusion as the first disk rotates.

Note that, as the acting protrusion is provided on one of the first disk and the second disk while the receiving groove is formed in the other, the acting protrusion is inserted into the receiving groove so that the first disk and the second disk are placed close to each other. Thus, the thickness of the filter device 1 can be reduced.

### Conclusion

As described above, the filter device 1 and the imaging apparatus 100 including the filter device 1 include: the first disk 2 including the first neutral density filter 8; the second disk 3 that is disposed to face the first disk 2 in the optical axis direction, and includes the second neutral density filter 11; and the first motor 29 that gives a driving force to the first disk 2 to rotate the first disk 2. The interlocking mechanism 50 that enables the second disk 3 to rotate with rotation of the first disk 2 is provided therein.

Accordingly, the first disk 2 is rotated by the driving force of the first motor 29, and the second disk 3 is made rotatable with rotation of the first disk 2 by the interlocking mechanism 50. Thus, the first disk 2 and the second disk 3 are rotated by the single first motor 29, and the filter device 1 and the imaging apparatus 100 can be made smaller in size by the decrease in the number of components and the simplification of the structure.

Furthermore, the acting protrusion 10 is provided on one of the first disk 2 and the second disk 3 while the receiving groove 13 is formed in the other. The driving force of the first motor 29 is transmitted to the second disk 3 via the first disk 2 while the acting protrusion 10 and the first opening edge 13a or the second opening edge 13b of the receiving groove 13 are in contact with each other. Thus, the first disk 2 and the second disk 3 are rotated together.

Accordingly, the interlocking mechanism 50 is formed with the acting protrusion 10 provided on the first disk 2 and the receiving groove 13 formed in the second disk 3. Thus, the structure of the interlocking mechanism 50 is simple, and the filter device 1 and the imaging apparatus 100 can be made even smaller in size.

Further, the acting protrusion 10 is provided on an inner peripheral portion of the first disk 2, and the receiving groove 13 is formed in an inner peripheral portion of the second disk 3.

Accordingly, the acting protrusion 10 and the receiving groove 13 are placed close to the rotation centers of the first disk 2 and the second disk 3, respectively. Thus, the diameters of the first disk 2 and the second disk 3 can be reduced, and the filter device 1 and the imaging apparatus 100 can be made even smaller in size.

Furthermore, the gear portion 2a is formed on an outer peripheral surface of the first disk 2, the first transmission gear 22a meshed with the gear portion 2a is provided, and the driving force of the first motor 29 is transmitted to the first disk 2 via the first transmission gear 22a.

Accordingly, the driving force of the first motor 29 is transmitted to the gear portion 2a formed on the outer peripheral surface of the first disk 2 to rotate the first disk 2. Thus, the accuracy of the rotational position of the first disk 2 can be increased, and the influence of backlash can be reduced.

Also, the first neutral density filter 8 is formed in a shape extending in a circumferential direction, and the degree of light reduction is continuously changed depending on the position of the second neutral density filter 11 of the second disk 3 with respect to the first neutral density filter 8 of the first disk 2.

Accordingly, the degree of light reduction is continuously changed by the first neutral density filter 8 and the second neutral density filter 11. Thus, luminance adjustment can be freely performed with the reduced number of components and the simplified structure.

In addition to the above, the engagement recesses 3a are formed on the outer peripheral surface of the second disk 3, and the click lever 34 that is pressed against the outer peripheral surface of the second disk 3 while being biased toward the second disk 3, and can be engaged with an engagement recess 3a is provided.

Accordingly, as the click lever 34 is engaged with an engagement recess 3a, the second disk 3 is held at a predetermined rotational position. Thus, the second disk 3 can be reliably held with a simple structure.

### One Embodiment of Imaging Apparatus

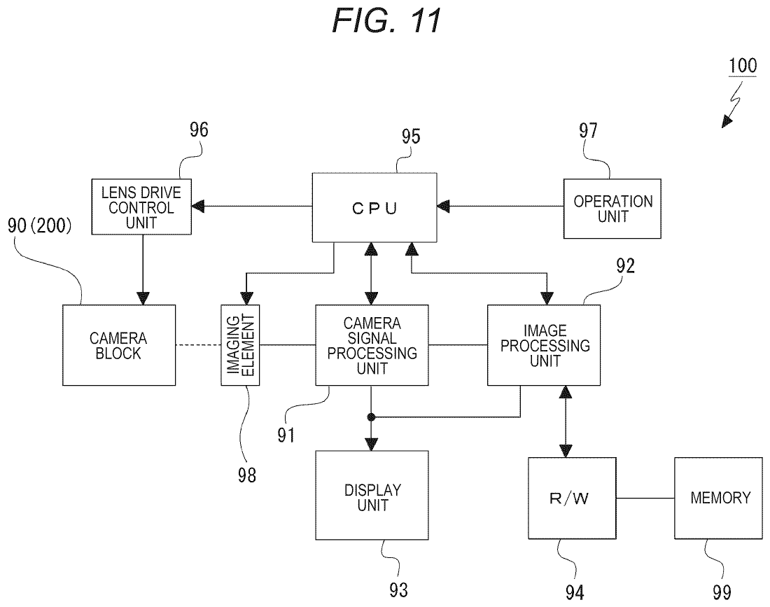

In the following, an example configuration of an embodiment of an imaging apparatus according to the present technology is described (see FIG. 11).

An imaging apparatus 100 is equipped with a camera block 90 having an imaging function, and includes: a camera signal processing unit 91 that performs signal processing such as analog-digital conversion of a captured image signal; and an image processing unit 92 that performs a recording/reproducing process on the image signal. Also, the imaging apparatus 100 includes: a display unit 93 that displays a captured image and the like; a reader/writer (R/W) 94 that writes and reads an image signal into and from a memory 99; a central processing unit (CPU) 95 that controls the entire imaging apparatus 100; a lens drive control unit 96 that controls driving of the lens disposed in the camera block 90; and an operation unit 97 such as various switches on which a user performs required operations.

The camera block 90 is an interchangeable lens (the lens device 200), for example.

The imaging apparatus 100 includes an imaging element 98 (imaging elements 105, 106, and 107) such as a CCD or a CMOS that converts an optical image captured by the camera block 90 into an electrical signal.

The camera signal processing unit 91 performs various kinds of signal processing such as conversion of an output signal from the imaging elements 98 into a digital signal, noise removal, image quality correction, and conversion into a luminance/color-difference signal.

The image processing unit 92 performs a compression encoding and decompression decoding process on an image signal based on a predetermined image data format, a conversion process on a data specification such as resolution, and the like.

The display unit 93 has a function of displaying various kinds of data such as an operating state of the user on the operation unit 97 and a captured image. Note that the imaging apparatus 100 may not be provided with the display unit 93, and may be designed so that captured image data is sent to another display device, and the image is displayed.

The R/W 94 writes image data encoded by the image processing unit 92 into the memory 99, and reads image data recorded in the memory 99.

The CPU 95 serves as a control processing unit that controls each circuit block provided in the imaging apparatus 100, and controls each circuit block on the basis of an instruction input signal or the like from the operation unit 97.

The lens drive control unit 96 controls a drive source that moves the lens on the basis of a control signal from the CPU 95.

The operation unit 97 outputs an instruction input signal in response to a user's operation, to the CPU 95.

The memory 99 is a semiconductor memory attachable to and detachable from a slot connected to the R/W 94, or a semiconductor memory incorporated beforehand into the imaging apparatus 100, for example.

In the following, operations in the imaging apparatus 100 are described.

In a standby state for imaging, under the control of the CPU 95, a captured image signal is output to the display unit 93 via the camera signal processing unit 91, and is displayed as a through-the-camera image. Furthermore, when an instruction input signal from the operation unit 97 is input, the CPU 95 outputs a control signal to the lens drive control unit 96, and the lens is moved on the basis of the control performed by the lens drive control unit 96.

When an imaging operation is performed in accordance with the instruction input signal from the operation unit 97, a captured image signal is output from the camera signal processing unit 91 to the image processing unit 92, is subjected to a compression encoding process, and is converted into digital data in a predetermined data format. The converted data is output to the R/W 94, and is written into the memory 99.

In a case where the image data recorded in the memory 99 is reproduced, predetermined image data is read from the memory 99 by the R/W 94 in response to an operation performed on the operation unit 97, and a decompression decoding process is performed by the image processing unit 92. After that, a reproduced image signal is output to the display unit 93, and a reproduced image is displayed.

Note that, in the present technology, the term “imaging” refers to processing including only some of or all of a series of processes starting from a photoelectric conversion process of converting captured light into an electrical signal by the imaging element 98, processing such as conversion of an output signal from the imaging element 98 into a digital signal, noise removal, image quality correction, and conversion into a luminance/color-difference signal by the camera signal processing unit 91, a compression encoding and decompression decoding process for an image signal based on a predetermined image data format, and a process of converting a data specification such as the resolution by the image processing unit 92, till a process of writing an image signal into the memory 99 by the R/W 94.

That is, “imaging” may refer to only a photoelectric conversion process of converting light captured by the imaging element 98 into an electrical signal, may refer to processing from a photoelectric conversion process of converting light captured by the imaging element 98 into an electrical signal to processing such as conversion of an output signal from the imaging element 98 into a digital signal, noise removal, image quality correction, conversion into a luminance/color-difference signal, or the like to be performed by the camera signal processing unit 91, may refer to processing from a photoelectric conversion process of converting light captured by the imaging element 98 into an electrical signal to a compression encoding and decompression decoding process for an image signal based on a predetermined image data format by the image processing unit 92 or a process of converting a data specification such as resolution via processing such as conversion of an output signal from the imaging element 98 into a digital signal, noise removal, image quality correction, conversion into a luminance/color-difference signal, or the like by the camera signal processing unit 91, may refer to processing from a photoelectric conversion process of converting light captured by the imaging element 98 into an electrical signal to processing such as conversion of an output signal from the imaging element 98 into a digital signal, noise removal, image quality correction, conversion into a luminance/color-difference signal, or the like by the camera signal processing unit 91, a compression encoding and decompression decoding process for an image signal based on a predetermined image data format by the image processing unit 92, or a process of converting a data specification such as resolution, or may refer to a process to be performed by the R/W 94 to write an image signal into the memory 99.

### Present Technology

The present technology may also have configurations as described below.

(1)

A filter device including:
a first disk including a first neutral density filter;
a second disk that is disposed to face the first disk in an optical axis direction, and includes a second neutral density filter; and
a motor that gives a driving force to the first disk to rotate the first disk, in which
an interlocking mechanism that enables the second disk to rotate with rotation of the first disk is provided.
   (2)

The filter device according to (1), in which
an acting protrusion is provided on one of the first disk or the second disk,
a receiving groove that extends in a circumferential direction and into which the acting protrusion is inserted is formed in another one of the first disk or the second disk,
the interlocking mechanism is formed with the acting protrusion and the receiving groove, and
the driving force of the motor is transmitted to the second disk via the first disk while the acting protrusion and an opening edge of the receiving groove are in contact with each other, to enable the first disk and the second disk to rotate together.
   (3)

The filter device according to (2), in which
the acting protrusion is provided on an inner peripheral portion of the first disk, and
the receiving groove is formed in an inner peripheral portion of the second disk.
   (4)

The filter device according to any one of (1) to (3), in which
a gear portion is formed on an outer peripheral surface of the first disk,
a transmission gear meshed with the gear portion is provided, and
the driving force of the motor is transmitted to the first disk via the transmission gear.
   (5)

The filter device according to any one of (1) to (4), in which
the first neutral density filter is formed in a shape extending in a circumferential direction, and
a degree of light reduction is continuously changed depending on a position of the second neutral density filter with respect to the first neutral density filter.
   (6)

The filter device according to any one of (1) to (5), in which
an engagement recess is formed in an outer peripheral surface of the second disk, and
a click lever that is pressed against the outer peripheral surface of the second disk while being biased toward the second disk and is engageable with the engagement recess is provided.
   (7)

The filter device according to any one of (1) to (6), in which
a third disk including a plurality of optical filters of different types positioned apart from each other in a circumferential direction is provided, and
the third disk is disposed to face the second disk in the optical axis direction.
   (8)

An imaging apparatus including:
an imaging element that converts an optical image into an electrical signal; and a filter device that performs luminance adjustment,
the filter device including:
a first disk including a first neutral density filter;
a second disk that is disposed to face the first disk in an optical axis direction, and includes a second neutral density filter; and
a motor that gives a driving force to the first disk to rotate the first disk, in which
an interlocking mechanism that enables the second disk to rotate with rotation of the first disk is provided.
   (9)

The filter device according to (8), in which
a low-pass filter is disposed apart from the filter device in the optical axis direction, and
a retardation plate is disposed between the filter device and the low-pass filter.

### REFERENCE SIGNS LIST

100 Imaging apparatus
102 Low-pass filter
103 Retardation plate
105 Imaging element
106 Imaging element
107 Imaging element
1 Filter device
2 First disk
2a Gear portion
3 Second disk
3a Engagement recess
4 Third disk
8 First neutral density filter
10 Acting protrusion
11 Second neutral density filter
13 Receiving groove
13a First opening edge
13b Second opening edge
14 Optical filter
22a First transmission gear
29 First motor
34 Click lever
50 Interlocking mechanism
98 Imaging element

1. A filter device comprising:
a first disk including a first neutral density filter;
a second disk that is disposed to face the first disk in an optical axis direction, and includes a second neutral density filter; and
a motor that gives a driving force to the first disk to rotate the first disk, wherein
an interlocking mechanism that enables the second disk to rotate with rotation of the first disk is provided.

2. The filter device according to claim 1, wherein
an acting protrusion is provided on one of the first disk or the second disk,
a receiving groove that extends in a circumferential direction and into which the acting protrusion is inserted is formed in another one of the first disk or the second disk,
the interlocking mechanism is formed with the acting protrusion and the receiving groove, and
the driving force of the motor is transmitted to the second disk via the first disk while the acting protrusion and an opening edge of the receiving groove are in contact with each other, to enable the first disk and the second disk to rotate together.

3. The filter device according to claim 2, wherein
the acting protrusion is provided on an inner peripheral portion of the first disk, and
the receiving groove is formed in an inner peripheral portion of the second disk.

4. The filter device according to claim 1, wherein
a gear portion is formed on an outer peripheral surface of the first disk,
a transmission gear meshed with the gear portion is provided, and
the driving force of the motor is transmitted to the first disk via the transmission gear.

5. The filter device according to claim 1, wherein
the first neutral density filter is formed in a shape extending in a circumferential direction, and
a degree of light reduction is continuously changed depending on a position of the second neutral density filter with respect to the first neutral density filter.

6. The filter device according to claim 1, wherein
an engagement recess is formed in an outer peripheral surface of the second disk, and
a click lever that is pressed against the outer peripheral surface of the second disk while being biased toward the second disk and is engageable with the engagement recess is provided.

7. The filter device according to claim 1, wherein
a third disk including a plurality of optical filters of different types positioned apart from each other in a circumferential direction is provided, and
the third disk is disposed to face the second disk in the optical axis direction.

8. An imaging apparatus comprising:
an imaging element that converts an optical image into an electrical signal; and a filter device that performs luminance adjustment,
the filter device including:
a first disk including a first neutral density filter;
a second disk that is disposed to face the first disk in an optical axis direction, and includes a second neutral density filter; and
a motor that gives a driving force to the first disk to rotate the first disk, in which
an interlocking mechanism that enables the second disk to rotate with rotation of the first disk is provided.

9. The imaging apparatus according to claim 8, wherein
a low-pass filter is disposed apart from the filter device in the optical axis direction, and
a retardation plate is disposed between the filter device and the low-pass filter.
